(19) United States
(12) Patent Application Publication
(10) Pub. No.: US 2012/0037303 A1
(43) Pub. Date: Feb. 16, 2012

(54) METHOD FOR ATTACHING A TEMPORARY MATERIAL TO A PIPING MODULE AND METHOD FOR CONVEYING A PIPING MODULE

(76) Inventors: Satoshi ARAI, Yokohama (JP); Shigeharu Tsunoda, Fujisawa (JP); Yoshio Oozeki, Yokohama (JP); Taihei Yotsuya, Tokyo (JP); Shizuo Imaoka, Fujimino (JP)

(21) Appl. No.: 13/179,798

(22) Filed: Jul. 11, 2011

(30) Foreign Application Priority Data
Aug. 11, 2010 (JP) 2010-180381

(51) Int. Cl. B32B 38/10; B32B 37/12

(52) U.S. Cl. 156/247

(57) ABSTRACT

To ensure required adhesion even when a pipe of a piping module collides with a temporary material during transport and achieve easier dismantling, the following measure is taken: the temporary material is fixed on a support rack to prevent the piping module placed on the support rack from largely displaced during conveyance and after the conveyance of the piping module, the temporary material is removed from the support rack. In this method, the following measures are taken: at the step of fixing the temporary material to the support rack, the temporary material is bonded to the support rack with the piping module set therein using adhesive; and at the step of removing the temporary material from the support rack after the conveyance of the piping module, the temporary material bonded to the support rack with the adhesive is peeled off from the support rack with heat applied thereto.

### BACKGROUND

The present invention relates to methods for attaching a temporary material to a piping module and methods for conveying a piping module and in particular to a method for attaching a temporary material to a piping module and a method for conveying a piping module favorably applicable to, for example, the construction of a nuclear power plant.

In construction of a power generating plant, for example, a nuclear power plant, structures are modularized to shorten the construction time of the nuclear power plant and the ratio of modularization has increased year after year. In general, modularization is carried out at production plants and modularized materials are conveyed to the installation sites of nuclear power stations by vehicle or ship.

In case of nuclear piping module, for example, pipes are temporarily fixed on a support rack by U-bolt or wire when they are conveyed. Further, temporary materials are fixed on a support rack for the prevention of major displacement of a pipe when they are conveyed. These temporary materials are dismantled after they are conveyed to the installation site of the nuclear power station. Welding has been conventionally used to temporarily join the temporary material and the support rack together. When a pipe collides with a temporary material during transport, the temporary material can be completely prevented form falling. Since the bonding strength is too high, however, it has taken much time to complete dismantling work. Specifically, all or part of the peripheral part of a temporary material is welded to a support rack and the weld is removed by grinder to dismantle them. The dismantling process takes much labor and time and this has posed a big problem.

Therefore, the duration and cost of the construction work for power generating plants can be reduced by adopting joining and a method in which required strength is ensured and dismantling is facilitated for these welded parts. As a method of joining a temporary material with dismantling taken into account, the following methods using adhesive have been recently proposed.

Chiaki Sato, “1.6 Recent Trend in Dismantlable Adhesive Technology,” Adhesion Technology, Japan, the Adhesion Society of Japan, Vol. 25, No. 3, (2005), Serial volume No. 80, pp. 25-29 (hereafter, referred to as Non-patent Document 1) describes the following: thermally expansible microcapsules are mixed in adhesive and dismantling is carried out by expansion force arising from the application of temperature.

Japanese Patent Application Laid-Open Publication No. 2004-189856 (hereafter, referred to as Patent Document 1) describes the following: thermal expansion graphite is contained in thermosetting adhesive and heat is applied to expand graphite and adhesive layers are peeled off by its expansion force.

Japanese Patent Application Laid-Open Publication No. 2009-51924 (hereafter, referred to as Patent Document 2) describes the following: a joint is formed of a rough joining surface A comprised of a stainless steel plate, an object B, and rubber adhesive placed between A and B; and when a load is applied in the direction of peeling, the joint can be easily dismantled by the rough surface effect of the stainless steel plate.

Japanese Patent Application Laid-Open Publication No. 2004-2548 (hereafter, referred to as Patent Document 3) describes the following: at least one wire rod is included in adhesive and dismantling can be easily carried out by peeling using this wire rod and heating.

It is known that the following problem arises in the methods using a thermally expansible member disclosed in Non-patent Document 1 and Patent Document 1: in case of structural adhesive high in bonding strength, for example, adhesive having a strength of 10 MPa or higher in tensile shear strength, the rate of reduction in strength is low and this makes dismantling (peeling) difficult. A large content of thermal expansion member enhances foaming force; in this case, however, there are observed many disadvantages, such as degradation in initial adhesive strength and significant increase in viscosity. In addition, the following big problem also arises: when pressure is applied to a temporary material, a thermal expansion material is deteriorated and predetermined expansion force cannot be obtained.

In the technology described in Patent Document 2, rubber adhesive is used as the adhesive. However, the rubber adhesive is prone to creep and it is difficult to apply it in terms of safety. This technology does not give consideration to the direction of application of peeling or bonding area and it is difficult to achieve both high adhesion and easy dismantlability with only this technology.

In the technology disclosed in Patent Document 3, dismantling is carried out by applying force in the direction of peeling using a wire rod. When the adhesive strength is high, however, the wire rod is broken and this makes dismantling difficult. When a thick wire rod is used, the following problem arises: adhesive layers are thickened and this causes reduction in shear strength and required adhesion cannot be ensured.

### SUMMARY

It is an object of the invention to provide a method for attaching a temporary material to a piping module in which even when a pipe in the piping module collides with the temporary material during transport, it is possible to ensure required adhesion and easily carry out dismantling and a method for conveying a piping module using this method. According to an aspect of the invention, it is possible to implement a method for attaching a temporary material to a piping module in which it is possible to ensure the adhesion of the temporary material and easily carry out dismantling by taking the following measure: the bonding length in the direction perpendicular to the direction in which a pipe is placed on the temporary material is maximized and the temperature of the adhesive joint is raised; and then peeling stress is exerted from a direction different from the direction in which the pipe is placed. According to an aspect of the invention, further, a method for conveying a piping module using the above attachment method can be implemented. As a result, it is possible to reduce the duration and cost for the construction work of a power generating plant.

In a method for attaching a temporary material to a piping module, the following measure is taken in the invention: to prevent the piping module placed on a support rack from being largely displaced during conveyance, the temporary material is fixed on the support rack; and after the conveyance of the piping module, the temporary material is removed from the support rack. To achieve the above object, the following measure is taken in the this method: at a step of fixing the temporary material on the support rack, the temporary material is bonded to the support rack with the piping module set therein using adhesive; and at a step of removing the temporary material from the support rack after the conveyance of the piping module, the temporary material bonded to the support rack with the adhesive is peeled off from the support rack with heat applied to the temporary material.

In a method for attaching a temporary material to a piping module, the following measure is taken in the invention: to prevent the piping module placed on a support rack from being largely displaced during conveyance, the temporary material is fixed on the support rack; and after the conveyance of the piping module, the temporary material is removed from the support rack. To achieve the above object, the following measure is taken in this method: at a step of fixing the temporary material on the support rack, the temporary material with the surface thereof at the bonding plane roughened is bonded to the support rack with the piping module set therein using epoxy adhesive; and at a step of removing the temporary material from the support rack after the conveyance of the piping module, the temporary material bonded to the support rack with the adhesive is peeled off from the support rack by taking the following measure: the temporary material is heated to reduce its peel strength lower than that at room temperature and it is peed off in this state.

In a method for conveying a piping module, further, the following measure is taken in the invention: major displacement of the piping module placed on a support rack is prevented by a temporary material fixed on the support rack and the piping module is conveyed to an installation site. To achieve the above object, the following measure is taken in this method: the temporary material is bonded to the support rack with the piping module set therein using adhesive; the piping module supported on the support rack with the temporary material bonded thereto is conveyed to an installation site of the piping module; at the installation site, the conveyed piping module is connected to another piping module; and the temporary material is peeled off from the support rack with heat applied to the temporary material bonded to the support rack supporting the piping module connected with the other piping module with the adhesive.

The invention is characterized in that the temporary material is bonded so that the bonding length in the direction perpendicular to the tangential direction of the pipe is shorter than the bonding length in the tangential direction.

Further, the invention is characterized in that when the temporary material is peeled off, it is peeled off from the tangential direction.

According to another aspect of the invention, it is possible to implement the following methods: a method for attaching a temporary material to a piping module in which it is possible to ensure the adhesion of the temporary material and easily carry out dismantling and a method for conveying a piping module using this method. Further, it is possible to ensure required adhesion and easily carry out dismantling in a temporary material on which the load of a pipe is applied during transport. This makes it possible to reduce the duration and cost of the construction work for a power generating plant.

These features and advantages of the invention will be apparent from the following more particular description of preferred embodiments of the invention, as illustrated in the accompanying drawings.

### BRIEF DESCRIPTION OF THE DRAWINGS

FIG. 1 is a perspective view illustrating the overall configuration of a piping module;

FIG. 2 is a flowchart illustrating the flow of assembling work for a piping module;

FIG. 3A is a front view illustrating the bonded structure of a temporary material to a piping module in Embodiment 1;

FIG. 3B is a side view illustrating the bonded structure of a temporary material to a piping module in Embodiment 1;

FIG. 3C is a sectional view taken along line A-A as viewed in the direction of arrows, illustrating the bonded structure of a temporary material to a piping module in Embodiment 1;

FIG. 4A is a plan view of a test piece illustrating an evaluation method for adhesive strength;

FIG. 4B is a front view of a test piece illustrating an evaluation method for adhesive strength;

FIG. 5 is a graph indicating shear strength and peel strength at room temperature and peel strength at 100° C. observed when acrylic adhesive is used;

FIG. 6 is a graph indicating the relation between bonding length a, b and tensile shear strength;

FIG. 7 is a graph indicating the relation between bonding area (a×b) and tensile shear strength;

FIG. 8 is a graph indicating the relation between bonding length a, b and peel strength;

FIG. 9 is a graph indicating the relation between bonding area (a×b) and peel strength;

FIG. 10 is a front view illustrating another mode of the bonded structure in the method for attaching a temporary material to a piping module in Embodiment 1;

FIG. 11 is a front view illustrating another mode of the bonded structure in the method for attaching a temporary material to a piping module in Embodiment 1;

FIG. 12 is a drawing illustrating another mode of the bonded structure in the method for attaching a temporary material to a piping module in a modification to Embodiment 1, corresponding to FIG. 3C, or the sectional view taken along line A-A as viewed in the direction of arrows;

FIG. 13 is a front view illustrating another mode of the bonded structure in the method for attaching a temporary material to a piping module in another modification to Embodiment 1;

FIG. 14 is a side view illustrating another mode of the bonded structure in the method for attaching a temporary material to a piping module in further another modification to Embodiment 1;

FIG. 15 is a side view illustrating another mode of the bonded structure in the method for attaching a temporary material to a piping module in further another modification to Embodiment 1;

FIG. 16 is a front view illustrating another mode of the bonded structure in the method for attaching a temporary material to a piping module in further another modification to Embodiment 1; and

FIG. 17 is a front view illustrating an example of the structure of a conventional temporary material for a piping module.

### DESCRIPTION OF THE PREFERRED EMBODIMENTS

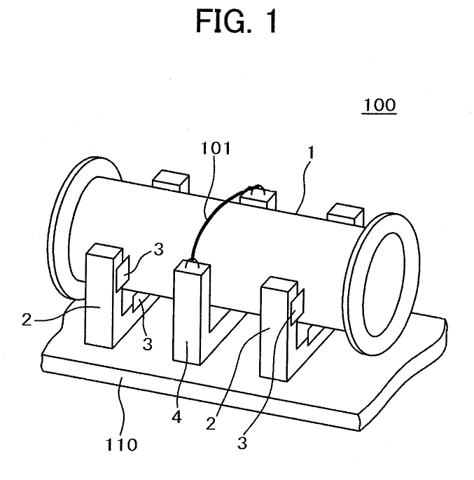

Hereafter, description will be given to an example of the bonded structure in a method for attaching a temporary material to a piping module of the invention with reference to the drawings. FIG. 1 illustrates the configuration of a piping module 100. The piping module 100 for power generating plants is including a pipe 1, a support rack 2, a temporary material 3, a support rack 4 bearing the load of the pipe, a valve (not shown), a wire 101, and a U-bolt (not shown). In the state of the module 100, the pipe 1 is fixed on the support racks 2 with a wire or U-bolt (not shown) and is transported as is placed on an operating mount 110. In general, carbon steel (SS400) is used as the material of the pipe 1, support racks 2, and temporary materials 3.

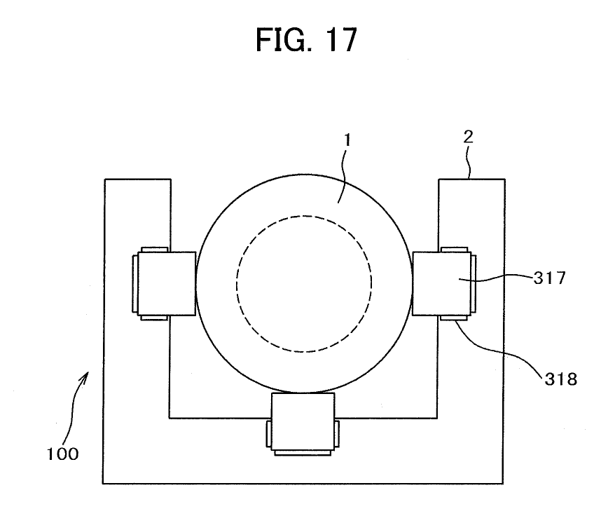

When a piping module is transported to an installation site and dismantled there, it conventionally takes a relatively long time and much labor to peel off a temporary material 317 welded 318 to a support rack 2 as illustrated in FIG. 17. Meanwhile, the invention adopts a method of joining a temporary material 3 to a support rack 2 with adhesive and this makes it possible to significantly reduce labor and time it takes to dismantle a piping module after transporting it to an installation site. Adoption of an attachment method using adhesive makes it unnecessary to use the same material as that of the support rack 2 for the temporary material 3 and this enables use of a metal material other than carbon steel.

Even in case of temporary material, the impactive load of the pipe 1, which weighs 1 ton or so, is applied thereto during transport for example; therefore, there is apprehension that the temporary material 3 is peeled off and falls. To prevent this, it is necessary to use acrylic or epoxy structural adhesive high in adhesive strength as the adhesive 5 for bonding the temporary material 3. In terms of workability, it is desirable to use two-part mixed adhesive that is cured at room temperature.

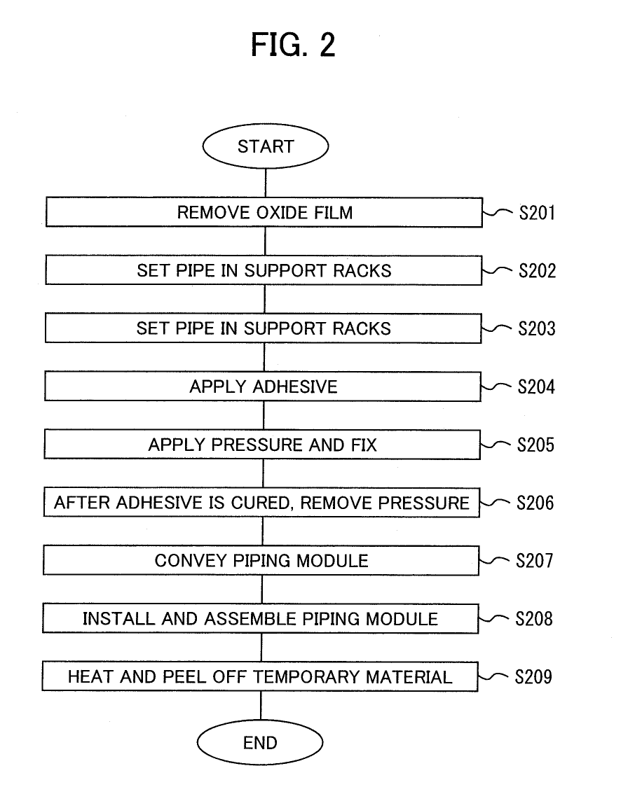

FIG. 2 illustrates an example of the flow of bonding work in an attachment method using adhesive. First, a black film, which is the oxide film of carbon steel (SS400), is removed beforehand from the adhesive joints between the temporary materials 3 and the support racks 2 (S201). At this time, it is desirable to use a wire brush or sandblasting; however, any other method is also acceptable as long as the oxide film can only be removed. Subsequently, dust and oil are completely wiped off with solvent, such as IPA, acetone, or heptane (S202). Thereafter, the separately fabricated pipe 1 is set in the support racks 2 (S203).

Subsequently, two adhesive liquids are mixed together and the resulting adhesive 5 is applied to a predetermined area of at least either of the temporary materials 3 and the support racks 2 (S204). The positions of the temporary materials 3 relative to the pipe 1 are adjusted so that the temporary materials 3 are substantially brought into contact with the pipe 1. Then, the temporary material 3 is pressed to the support rack 2 by using a clamp to fix them together (S205). The pipe 1 may be inserted after fixing the temporary material 3 to the support rack 2, depending on the work to be conducted. They are left clamped for a certain period. After the adhesive 5 is completely cured, the clamp is removed from the temporary material 3 and the support rack 2 to remove pressure (S206). When the coefficient of elasticity of the adhesive 5 is too low at this time, large displacement is caused by creeping. Therefore, it is desirable that the coefficient of elasticity of the adhesive should be 100 MPa or above, preferably, 400 MPa or above.

After the bonding work is conducted in accordance with the above procedure, the piping module is mounted on the operating mount 110 and is transported by vehicle or ship (S207). Thereafter, the piping module is formally installed on the installation site of the power generating plant by welding the pipe 1 to other pipe (not shown) or other work (S208) and then the temporary materials 3 are dismantled (S209). To dismantle them, the temperature of the adhesive joints is raised high with a burner or a heater and then peeling stress is exerted on the adhesive joints. At this time, it is desirable to raise the temperature of the entire adhesive joints high. When the bonding area is large, however, only the adhesive joint area located in proximity to the area where peeling stress is exerted has to be heated.

### Embodiment 1

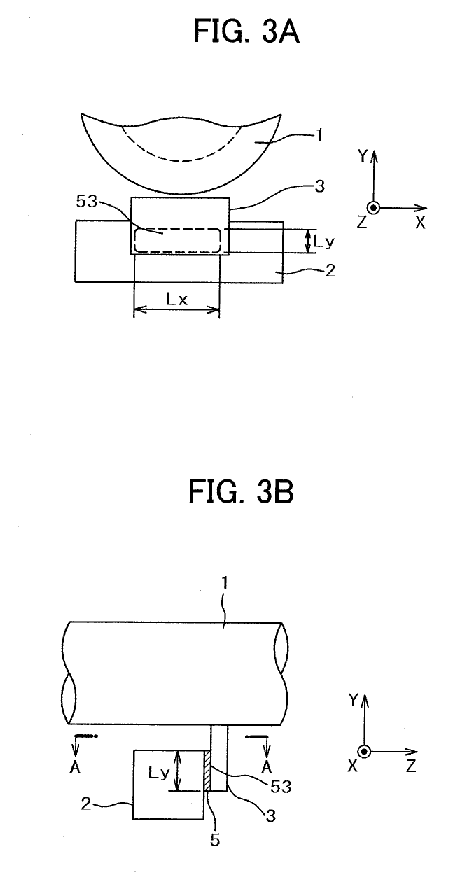

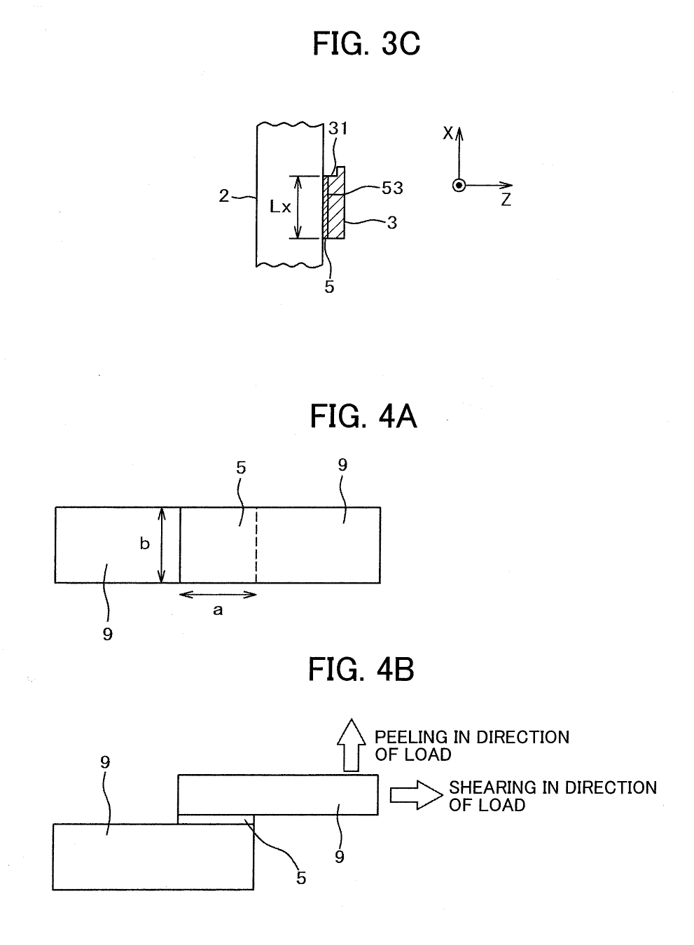

FIG. 3A is a front view illustrating the bonded structure in a method for attaching a temporary material to a piping module and a dismantling method of the invention; FIG. 3B is a side view thereof; and FIG. 3C is a sectional view taken along line A-A of FIG. 3B as viewed in the direction of arrows. In this embodiment, the temporary material 3 is bonded and fixed to the support rack 2 with adhesive 5 at the bonding plane 53. This bonded structure is characterized in that when the temporary material 3 is attached, the bonding length (LX) in the direction which is parallel to a tangent line of the pipe 1 in the sectional plane (X direction in FIG. 3A) is larger than the following bonding length: the bonding length (LY) in the direction (Y direction in FIG. 3A) perpendicular to the tangential direction in the sectional plane of the pipe 1. Further, the bonded structure is characterized in that it is so configured that the following can be implemented after the module is transported to the installation site and is installed by welding to other unit, for example: the temporary material 3 can be easily dismantled (peeled off) by raising the temperature of the adhesive joint area high and exerting peeling stress to the adhesive joint area from the direction (X direction) perpendicular to the direction in which the pipe 1 is placed.

Hereafter, detailed description will be given to how to attach a temporary material 3 to a support rack 2.

When this module 100 is conveyed by vehicle or ship, the pipe 1 may be largely displaced and collide with the temporary material 3. This collision applies a load to the temporary material 3 bonded and fixed to the support rack 2 mainly in the direction of shear. However, there is apprehension that the load of peeling is also applied to the temporary material 3 depending on the mode of displacement. With respect to adhesive strength, therefore, it is required that shear strength and peel strength should be high in the direction (Y direction in FIG. 3A) in which the pipe 1 collides with the temporary material 3. When the temporary material 3 bonded and fixed to the support rack 2 is dismantled (peeled off) from the support rack 2, it is necessary to peel off the adhesive joints by a method in which the adhesive strength can be reduced as much as possible.

FIGS. 4A and 4B illustrate an evaluation method for adhesive strength. In these drawings, “a” is taken for the bonding length to the shearing forth loading direction in a shearing plane and “b” is taken for the bonding length in the direction perpendicular thereto. A carbon steel (SS400) material with a black film (oxide film) removed from the surface thereof was used as the material of the test piece 9. Two-part mixed acrylic adhesive, 60° C. in glass transition temperature (peak value of tan δ), was used as the adhesive 5. A fillet portion was shaven after bonding. In evaluating the strength, a load was applied not only to the shearing direction but also to the pealing direction by considering the needed adhesive strength and the stress caused by dismantling the temporary material 3 from the support rack 2. The load rate was 50 mm/min both in the shearing test and in the peeling test.

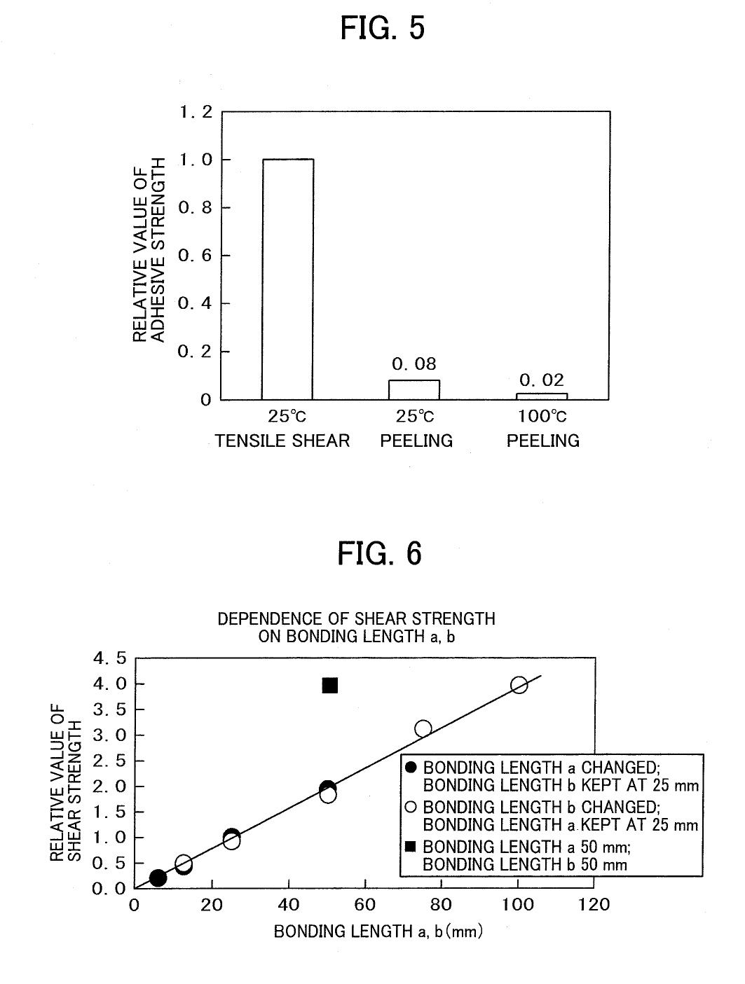

FIG. 5 shows shear strength (tensile shear strength) and peel strength at room temperature and peel strength at 100° C. as an example of high temperature. FIG. 5 shows relative values of strengths when the shear strength at room temperature with bonding length “a” set to 25 mm and bonding length “b” set to 25 mm is set to 1. As a result, it was found that the peel strength at room temperature was as small as 1/10 of the shear strength at room temperature. Further, it was found that the peel strength at 100° C. was further reduced to ¼ of the peel strength at room temperature. These failure modes are all cohesive failure which occurs in the adhesive. Therefore, peeling under high-temperature with low peeling stress facilitates dismantling. However, there is a problem: the peel strength at room temperature is low with only this technique.

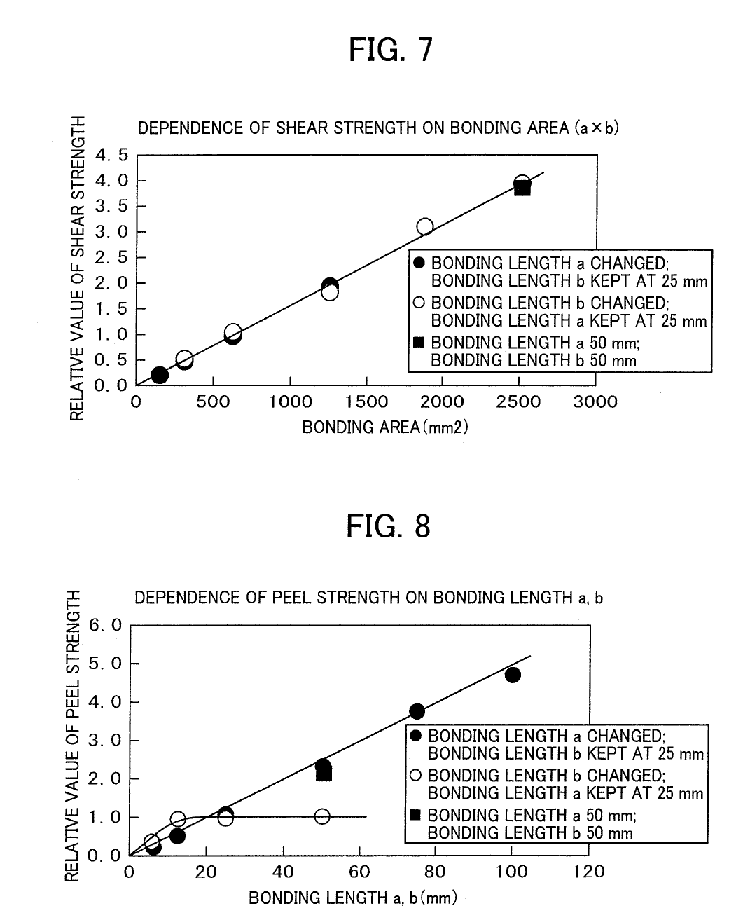

FIG. 6 and FIG. 7 show the relation between bonding lengths a, b and shear strength (tensile shear strength). It is seen from the graph in FIG. 6 that the shear strength is in proportion to the bonding length both in the direction of “a” and in the direction of “b”. As a result, it is seen from the graph in FIG. 7 that the shear strength is proportionally increasing with the increase of bonding area. That is, it is seen that the shear strength does not depend on the direction in which a load is applied. It was experimentally verified that the proportional relation between shear strength and bonding area holds in case of the following adhesive: an adhesive whose coefficient of elasticity is not more than 1.5 GPa and which develops cohesive failure. It was experimentally verified that especially in an adhesive whose coefficient of elasticity is large and which develops interfacial failure, stress concentration on a bonding end occurs and the shear strength is not in proportion to bonding area.

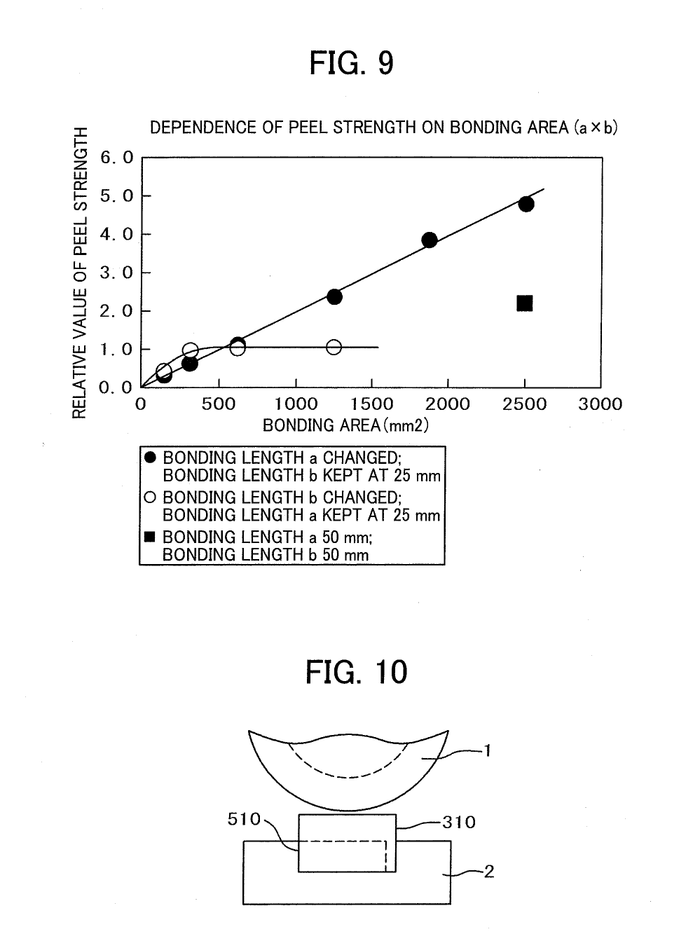

FIG. 8 and FIG. 9 show the relation between bonding length “a”, “b” and peel strength. It is seen from the graph in FIG. 8 that the peel strength is saturated when the bonding length “b” is not less than 12.5 mm and it is in proportion to the bonding length “a” but not in proportion to the bonding length “b”. That is, unlike the trend in shear strength shown in FIG. 6, it is seen that the peel strength depends on the bonding length “a”. The following was experimentally verified with respect to peel strength: other adhesives 5 (acrylic adhesives and some of epoxy adhesives) that cause cohesive failure also have this trend; and the same trend is observed at high temperature, for example, 100° C.

Ease of dismantling (peeling) depends on the difference between temperature applied during dismantling and the glass transition temperature of adhesive 5. However, it is difficult to actually heat adhesive joints to several hundred degrees ° C. on the site where a power generating plant is installed. Consequently, in consideration of that the temperature of temporary materials is raised to 50° C. or so during transport, it is desirable to use the following material for the adhesive 5: a material whose glass transition temperature is within a range of 60 to 80° C. and which can be dismantled at not less than 100° C., which is a temperature higher by 20° C. than the glass transition temperature.

For the above-mentioned reasons, it is possible to ensure required adhesive strength and carry out dismantling by taking the following measures: the bonding length in the direction (X direction in FIG. 3B) perpendicular to the direction in which the pipe 1 is placed is made longer than the bonding length in the direction (Y direction in FIG. 3A) in which pipe 1 is placed on the temporary material 3; and in dismantling, the temperature of adhesive joints is raised high and peeling stress is exerted from the direction (X direction in FIG. 3B) perpendicular to the direction in which the pipe 1 is placed.

It is desirable that the adhesive should be prepared so that the following is implemented to cause cohesion failure: the coefficient of elasticity at room temperature is not less than 100 MPa and not more than 1.5 GPa, more preferably, not less than 400 MPa and not more than 1.5 GPa.

In consideration of the work of actually applying adhesive, there are cases where it is difficult to increase the bonding area. Consequently, it is advisable to take, for example, the following measure: the bonding length in the direction (X direction in FIG. 3A) in parallel to a tangent line to the section of the pipe 1 when the temporary materials 3 are attached is set to 100 mm; and the length in the direction (Y direction in FIG. 3A) perpendicular to a tangent line to the section of the pipe 1 is set to 12.5 mm. This makes it possible to make the peel strength at 100° C. from the direction (X direction in FIG. 3A) perpendicular to the direction in which the pipe 1 is placed equal to the following: 1/400 of the shear strength at room temperature in the direction (Z direction in FIG. 3A) in which the pipe 1 is placed on the temporary material 3. As a result, it is possible to achieve both ensuring adhesive strength and easily carrying out dismantling.

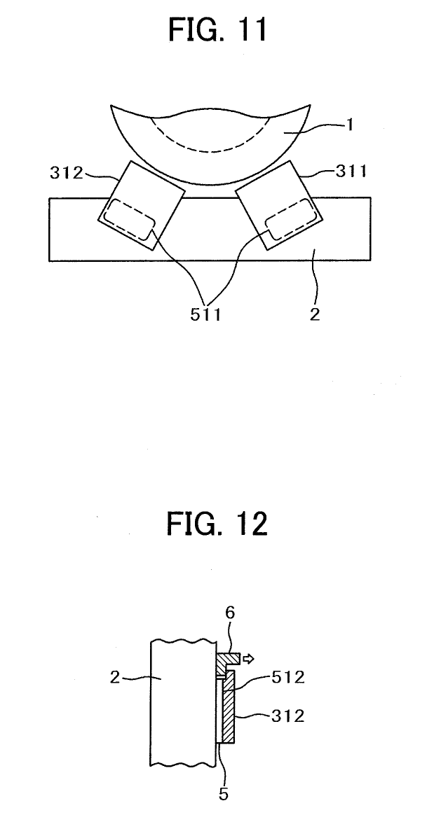

In dismantling, a wedge or a claw bar can be used to exert peeling stress. In terms of ease of dismantling, however, it is desirable to take the following measure in dismantling: a stepped portion 31 is formed at an end portion of a temporary material 3 and a dismantling jig 6, a wedge, or a claw bar is driven into this stepped portion to exert peeling stress. Variation can be reduced by making the following areas equal to each other as illustrated in FIG. 10: the area of contact between the temporary material 310 and the support rack 2 and the area of the bonding plane 510. The method for arranging temporary materials 3 may be changed depending on the number and positions of placed support racks 2. Or, the following measure may be taken as illustrated in FIG. 11: temporary materials 311 and 312 are slantly provided on one support rack 2 in two places and each temporary material is bonded at a bonding plane 511.

(Modification 1)

FIG. 12 is a sectional view taken along line A-A as viewed in the direction of arrows, corresponding to FIG. 3C, illustrating a modification to the bonded structure in the method for attaching a temporary material to a piping module of the invention. Peeling planes can be selectively controlled by making the surface roughness of the bonding plane 512 of the temporary material 312 larger than the surface roughness of the bonding plane of the support rack 2. It is desirable that the difference in bonding roughness should be equal to or larger than the Ra difference of 3 μm. In this case, it is advisable to use the following adhesive as the adhesive 5: an epoxy adhesive whose coefficient of elasticity at room temperature is not less than 1.5 GPa and not more than 5 GPa, relatively susceptible to interfaces.

In this configuration, interfacial failure is developed on one side; therefore, the shear strength and the bonding area are not in proportion to each other. However, it has been experimentally verified that the shear strength is in proportion to the bonding length “b” in FIG. 6. For this reason, this structure provides an effective means only in places where a load in the direction of shear is small when the pipe weight is not so heavy and is several hundred kilograms or so. In this case, it is advisable to use an epoxy adhesive low in viscosity so that the adhesive sufficiently penetrates into roughened interfaces and heat the adhesive 5 or taken other like measures to reduce its viscosity when applied if it is too viscous.

(Modification 2)

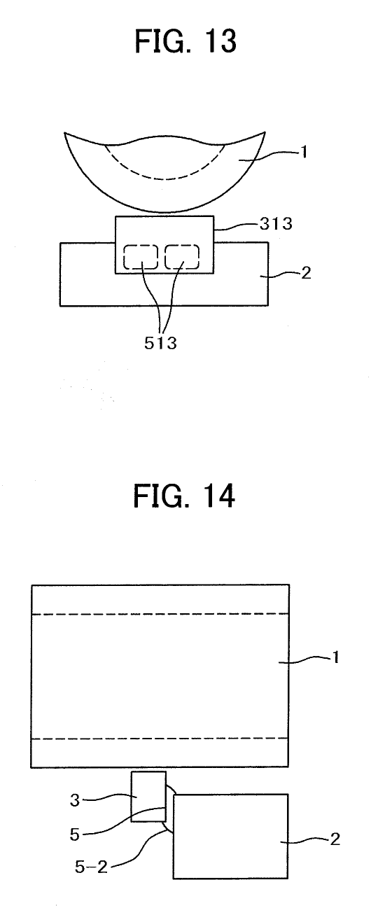

FIG. 13 is a front view illustrating further another modification to the bonded structure in the method for attaching a temporary material to a piping module of the invention. As illustrated in the drawing, the bonding place in each temporary material 313 may be divided into two 513 in terms of workability. Also in this case, the following measure only has to be taken: the total bonding length in two places in the direction (X direction in FIG. 3A) in parallel to a tangent line to the section of the pipe 1 is made longer than the bonding length in the direction (Y direction in FIG. 3A) perpendicular to a tangent line to the section of the pipe 1.

However, the peel strength in the perpendicular direction is higher when two bonding places are provided and the bonding length is identical than in the case illustrated in FIG. 3A. That is, the peel strength is higher than when the bonding length in the direction (Y direction in FIG. 3A) perpendicular to a tangent line to the section of the pipe 1 is taken in one place like the bonding place 53. This case can be coped with by reducing the bonding length. The number of bonding places is not limited to two and any number of bonding places may be provided.

(Modification 3)

FIG. 14 is a side view illustrating further another modification to the bonded structure in the method for attaching a temporary material to a piping module of the invention. The adhesive strength can be enhanced by forming a fillet 5-2 between a temporary material 3 and a support rack 2 as illustrated in this drawing and this contributes to the enhancement of safety of the pipe 1 against impact. In dismantling, it is advisable to shave the fillet 5-2 surface and then apply high temperature and peeling stress. In terms of the number of man-hours for dismantling work at this time, the fillet 5-2 ought to be formed only in the direction in which the pipe 1 is placed; however, the fillet 5-2 may be formed on the entire circumference.

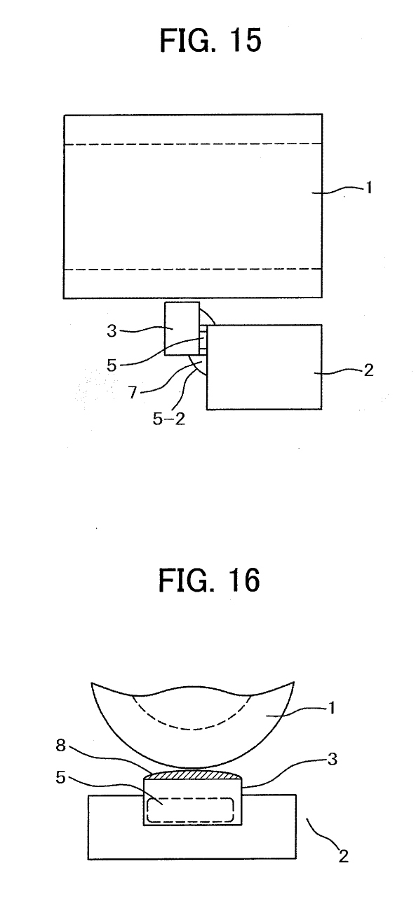

As illustrated in FIG. 15, an adhesive 7 other than the adhesive for fixing the temporary material 3 and the support rack 2 together may be used for the adhesive for forming the fillet 5-2. In consideration of resistance to impact, in this case, it is desirable to use the following adhesive as the adhesive 7 for forming the fillet 5-2: an adhesive whose coefficient of elasticity is lower than that of the adhesive 5 for fixing the temporary material 3 and the support rack 2 together. In this case, aside from acrylic and epoxy adhesives, a urethane adhesive cured at room temperature may be used as the adhesive 7.

(Modification 4)

FIG. 16 is a front view illustrating further another modification to the bonded structure in the method for attaching a temporary material to a piping module of the invention. The resistance to impact can be enhanced by sandwiching a rubber material (elastomer) or adhesive 8 between the temporary material 3 and the pipe 1 in places where they are brought into contact with each other during transport as illustrated in the drawing. It is desirable to use a rubber material or adhesive 8 whose coefficient of elasticity is not more than 50 MPa. In case of adhesive 8, the adhesive 5 bonding the temporary material 3 and the support rack 2 together may be used also for this purpose. When a rubber material 8 is used, it is advisable to select an adhesive excellent in adhesion between the rubber material 8 and the temporary material 3.

In the above description of the embodiments, a method for attachment to a piping module for power generating plants has been taken as an example. However, this attachment method is effective not only for piping modules but also for bonded structures and methods involving dismantling. The bond may be in any shape including ellipse and parallelogram and there may be multiple adhesive joints based on the guidelines described up to this point.

In recent years, structures have been modularized to shorten the construction time in building a power generating plant, for example, a nuclear power plant and the ratio of modularization has increased year after year. As the modularization work increases, it has become necessary to effectively dismantle temporary materials. Use of each embodiment described up to this point makes easier to conduct dismantling work than in conventional cases using welding. Also in terms of safety, the structure described in relation to each embodiment makes it possible to ensure required adhesive strength. Therefore, carrying out the invention significantly contributes to achievement of reduction of the duration and cost of the construction work for power generating plants.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

1. A method for attaching a temporary material to a piping module, comprising the steps of:
fixing a temporary material to a support rack to prevent a piping module including a pipe placed on the support rack from being largely displaced during conveyance; and
removing the temporary material from the support rack after the conveyance of the piping module,
wherein at the step of fixing the temporary material to the support rack, the temporary material is bonded to the support rack with the piping module set therein using adhesive, and
wherein at the step of removing the temporary material from the support rack, the temporary material bonded to the support rack with the adhesive is peeled off from the support rack with heat applied thereto.

2. The method for attaching a temporary material to a piping module according to claim 1,
wherein the adhesive is an adhesive that develops cohesive failure when the temporary material is peeled off from the support rack with heat applied thereto.

3. The method for attaching a temporary material to a piping module according to claim 1,
wherein the glass transition temperature of the adhesive is within a range of 60° C. to 80° C.

4. The method for attaching a temporary material to a piping module according to claim 1,
wherein the coefficient of elasticity of the adhesive is within a range of 100 MPa to 1.5 GPa.

5. The method for attaching a temporary material to a piping module according to claim 1,
wherein at the step of removing the temporary material from the support rack, the temporary material is heated to a temperature higher than the glass transition temperature of the adhesive to be peeled off from the support rack.

6. The method for attaching a temporary material to a piping module according to claim 1,
wherein the adhesive is an adhesive of such a type that two liquids are mixed when used.

7. A method for attaching a temporary material to a piping module, comprising:
fixing a temporary material to a support rack to prevent a piping module placed on the support rack from being largely displaced during conveyance; and
after the conveyance of the piping module, removing the temporary material from the support rack,
wherein at the step of fixing the temporary material to the support rack, the temporary material with the surface thereof roughened at the bonding plane is bonded to the support rack with the piping module set in using epoxy adhesive, and
wherein at the step of removing the temporary material from the support rack, the temporary material bonded to the support rack with the adhesive is peeled off from the support rack with heat applied thereto to make the peel strength lower than the peel strength at room temperature.

8. The method for attaching a temporary material to a piping module according to claim 7,
wherein at the step of removing the temporary material from the support rack, the temporary material is heated to a temperature higher than the glass transition temperature of the epoxy adhesive to be peeled off from the support rack.

9. The method for attaching a temporary material to a piping module according to claim 7,
wherein the glass transition temperature of the epoxy adhesive is within a range of 60° C. to 80° C.

10. The method for attaching a temporary material to a piping module according to claim 7,
wherein at the step of removing the temporary material from the support rack, the temporary material is heated to a temperature higher than the glass transition temperature of the epoxy adhesive to be peeled off from the support rack.

11. The method for attaching a temporary material to a piping module according to claim 7,
wherein the coefficient of elasticity of the epoxy adhesive is within a range of 1.5 GPa to 5 GPa.

12. The method for attaching a temporary material to a piping module according to claim 7,
wherein at the step of removing the temporary material from the support rack, the temporary material is peeled off from the support rack with heat applied thereto to a temperature of 100° C. or so.

13. The method for attaching a temporary material to a piping module according to claim 7,
wherein at the step of fixing the temporary material to the support rack, the temporary material is bonded to the support rack so that the bonding length in the direction perpendicular to the tangential direction of the pipe is shorter than the bonding length in the tangential direction.

14. The method for attaching a temporary material to a piping module according to claim 7,
wherein at the step of removing the temporary material from the support rack, the temporary material is peeled off from a tangential direction of a pipe of the piping module.

15. A method for conveying a piping module in which major displacement of a piping module placed on a support rack is prevented by a temporary material fixed on the support rack and the piping module is conveyed to an installation site, the method comprising the steps of:
bonding the temporary material to the support rack with the piping module set therein using adhesive;
conveying the piping module supported on the support rack with the temporary material bonded thereto to the installation site of the piping module;
connecting the conveyed piping module with another piping module on the installation site; and
peeling the temporary material bonded to the support rack supporting the piping module connected with the other piping module with adhesive off from the support rack with heat applied thereto.

16. The method for conveying a piping module according to claim 15,
wherein at the step of peeling, the temporary material is heated to a temperature higher than the glass transition temperature of the adhesive to cause cohesive failure in the adhesive when peeling off the temporary material from the support rack.
